(19) United States
(12) Patent Application Publication
(10) Pub. No.: US 2015/0129732 A1
(43) Pub. Date: May 14, 2015

(54) UTILITY HOOK APPARATUS

(71) Applicant: Nicholas Propersi, Bloomington, IL (US)

(72) Inventor: Nicholas Propersi, Bloomington, IL (US)

(73) Assignee: PROPERSI PRODUCTIONS LLC, Las Vegas, NV (US)

(21) Appl. No.: 14/537,146

(22) Filed: Nov. 10, 2014

Related U.S. Application Data
(60) Provisional application No. 61/902,531, filed on Nov. 11, 2013.

(51) Int. Cl. A47G 25/28; A47G 25/32; F16M 13/02

(52) U.S. Cl. CPC A47G 25/28; F16M 13/022; A47G 25/32
USPC 248/304

(57) ABSTRACT

A utility hook supports free-standing objects. The hook includes an arm member having two ends with one end connecting to an open-ended catch and the other end connecting to a shoulder member. A hook member is connected to the arm member via the shoulder member. A band engages with the open-ended catch and has a thickness. The arm member and the hook member are substantially parallel. The open-ended catch has a securing gap disposed between that and the back of the arm member. The securing gap having a distance smaller than that of the thickness of the band.

### CROSS-REFERENCE TO RELATED APPLICATIONS

This is a non-provisional application of provisional application Ser. No. 61/902,531, filed on Nov. 11, 2013, whose content is incorporated by reference in its entirety.

### BACKGROUND

Space is a luxury that has become more and more expensive as time has progressed. Airlines and other transportation methods have place a premium on space in an attempt to gain any possible financial edge. Certain items are just difficult to travel with, one of which is jackets and coats. A passenger will encounter a number of problems when traveling with a coat via airplane. First, there is no room in the overhead bin to place a sport coat/jacket. Secondly, if there is room to put it in the overhead bin, it would have been pushed into a corner and wrinkled. This issue is particularly unacceptable for individuals traveling on business with a suit jacket. Additionally, the personal item is often on top or pressed against someone else's luggage which could lead to uncleanliness and bed bugs.

Outside the context or airplanes, there is a need for a portable device that can be hung. For example, handles of strollers, pull-behind briefcases, chair arm rests, etc., are all suitable and portable objects that are capable of supporting object conveniently and on an impromptu/ad hoc situation. Most devices in the current market require a permanent fixture by way of screws in a wall or is a single-use replaceable hook. Neither has the flexibility to be used as a portable device. A traveler may need a place to hang a coat in a car, then on a piece of luggage, and then on the plane.

### SUMMARY

Aspects of the invention improve over the prior technology by creating a utility hook that can be used in a variety of ways and supports objects of various sizes and weights. The hook comprises an arm member having an open-ended catch. The hook also a hook member connected to the arm member by a shoulder member. The hook member has a detachable band. The band engages with the open-ended catch. The arm member and the hook member are substantially parallel.

Moreover, embodiments of the invention may be disposed on a hook, attachments on the back of a seat, handles of strollers, pull-behind briefcases, chair arm rests, etc. Embodiments of the invention provide a hook support where there is typically none or on an impromptu/ad hoc situation when support is desirable and yet does not physically alter the original structure of the supporting object. For example, aspects of the invention may be used on a luggage handle or on a wall of a home. Lastly, alternative uses of embodiments of the invention seek to provide versatile support for varying items.

### BRIEF DESCRIPTION OF THE DRAWINGS

FIG. 1 is a perspective view of a utility hook without a band according to one embodiment of the invention.

FIG. 2 is a perspective view of a utility hook having a band according to one embodiment of the invention.

FIG. 3 is a side profile view of a utility without a band according to one embodiment of the invention.

FIG. 4 is a side view of a utility hook with a band according to one embodiment of the invention.

FIG. 5 is a front view of a utility hook according to one embodiment of the invention.

FIG. 6 is a perspective view of a utility hook with a band hanging off an object according to one embodiment of the invention.

FIG. 7 is a perspective view of the utility hook having a band hanging off a horizontal object according to one embodiment of the invention

FIG. 8 is a perspective view of a utility hook having a band with looped configuration according to one embodiment of the invention.

### DETAILED DESCRIPTIONS

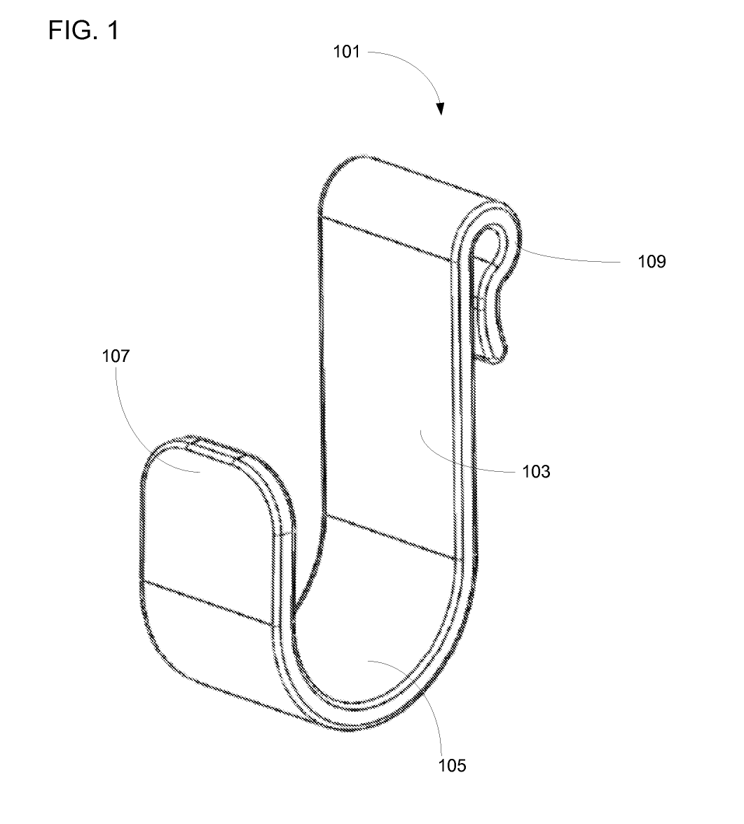

Reference will now be made to the drawings wherein like reference numbers refer to like components throughout. FIG. 1 is perspective view of one embodiment of the utility hook 101 without a band according to one embodiment of the invention. In one example, the utility hook 101 includes an arm member 103, a shoulder member 105, a hook member 107, and an open-ended catch 109. The utility hook 101 may be created from one continuous piece of material. In one example, the materials may include, without limitation: metals, polymers, wood, composites, plastics, etc. In one embodiment, the utility hook 101, especially the open-ended catch 109, is made of inflexible materials that maintain a certain degree of stiffness.

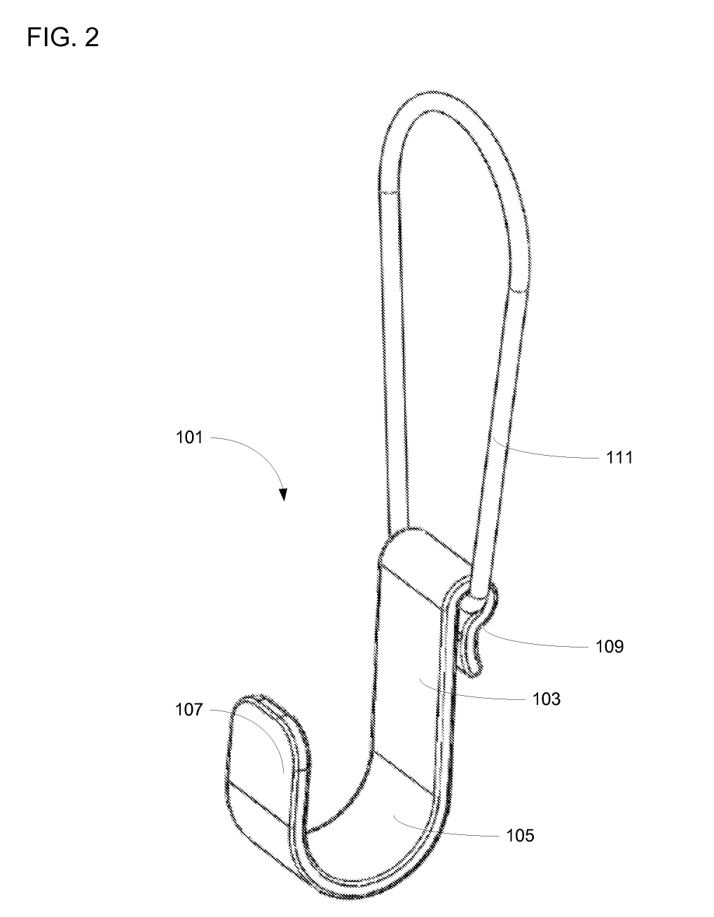

Referring to FIG. 2, a perspective view of a utility hook 101 includes a band 111 according to one embodiment of the invention. In this example, the band 111 may be a detachable loop, a detachable elastic band, or an elastic loop or circle, such as a rubber band. In another embodiment, the band 111 may be made of rubber, metal, or leather. In another example, the band 111 may be of a thickness of 2.5 millimeter (mm).

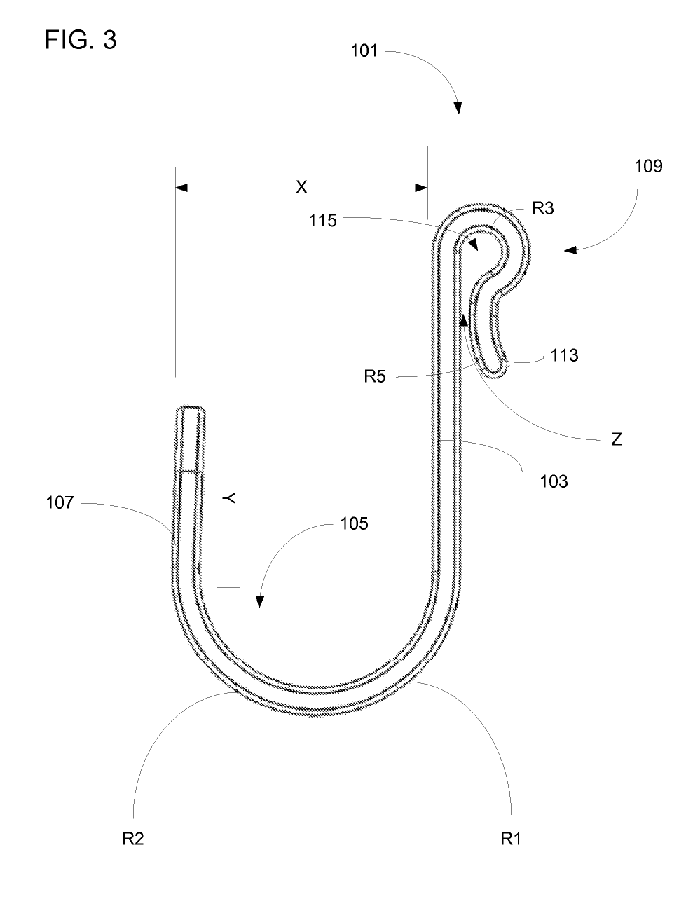

Referring to FIG. 3, a side view of the utility hook 101 without the band 111 according to one embodiment of the invention is shown. In this example, the arm member 103 and the hook member 107 is substantially parallel. In another embodiment, an angle X between the arm member 103 and the hook member 107 is 2 degrees. Also, the arm member 103 may have a smooth surface for printing texts, graphics, etc., thereon. In one embodiment, the shoulder member 105 includes two curvature measurements. For example, R1 has a curvature or a radius of about 11.0 mm while R2 has a curvature or a radius of about 13.5 mm. In a further embodiment, the hook member 107 has a length of Y, such as about 15.4 mm.

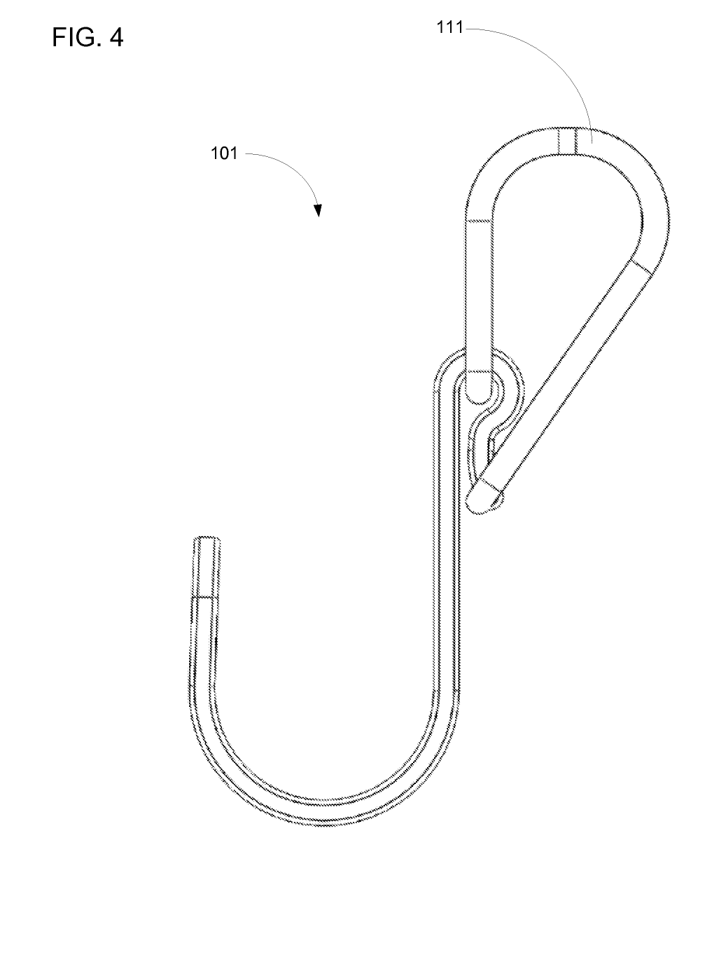

Still referring to FIG. 3, in another embodiment, the utility hook 101 may be of a thickness of about 2.5 mm. In another embodiment, the open-ended catch 109 includes at least one of the curvature or radius measurements: R3 is about 2 mm; R4 is about 1.3 mm; R5 is about 10.5 mm. In another embodiment, a distance Z between an end of the open-ended catch 109 and the back of the arm member 103 is about 0.9 mm. See also FIG. 4, another side view the utility 101 with the band 111 according to one embodiment of the invention. In this example, the thickness of the band 111 is greater than Z so as to restrict the movement of the band 111 in and out of the open-ended catch 109. However, upon stretching the band 111, the band 111 may be pulled out of the open-ended catch 109.

In one example, the materials of the utility hook 101 may include substantially sufficient strength for support a weight of a purse or a jacket. As described earlier, the hook member 107 and the arm member 103 are substantially parallel to allow the space for a variety of items ranging from a thing coat hanger to a thick purse handle. The shoulder member 105 connects the hook member 107 with the arm member 103 and facilitates the item to be supported. For example, the shoulder member 105 provides a space or a surface area to accommodate or receive the item to be hanged. In another embodiment, the shoulder member 105 is rounded to allow more area to place the supported item. It is to be understood that the shoulder member 105 may be of other shapes or surface types without departing from the scope or spirit of the aspects of the invention.

In another embodiment, one end of the open-ended catch 109 is connected to the arm member 103, as shown in FIGS. 1-4, while the other end is freestanding to secure the detachable band 111, see also FIGS. 2 and 4.

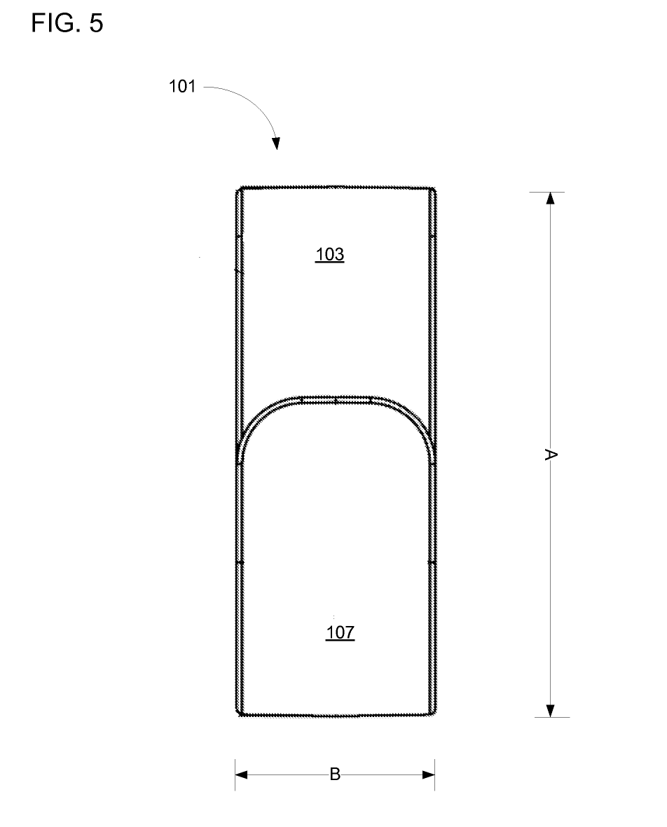

Referring to FIG. 5, a frontal view of the utility hook 101 is shown. In one embodiment, A has a length of 48 mm and B has a width of 18 mm.

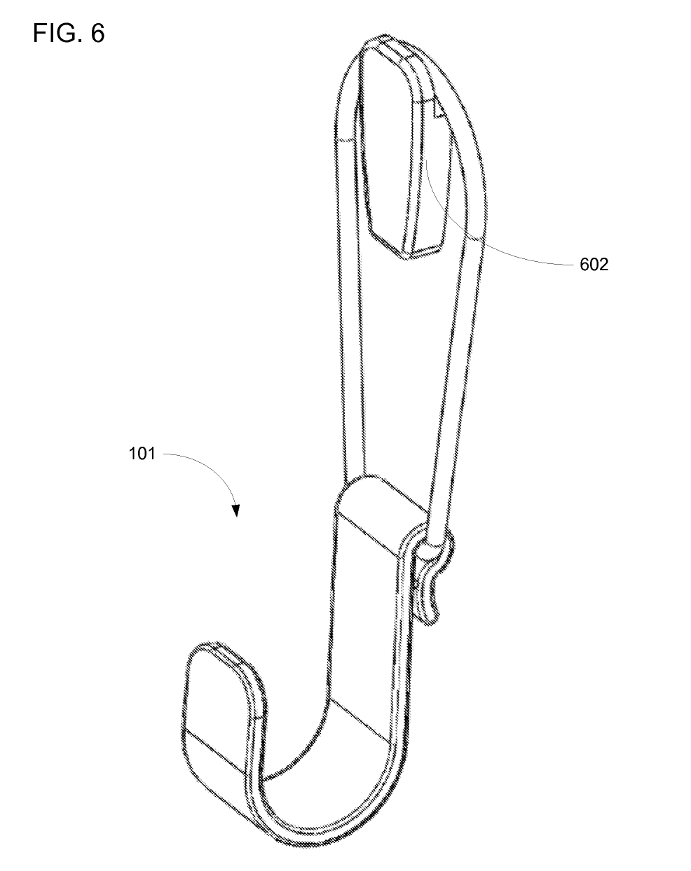

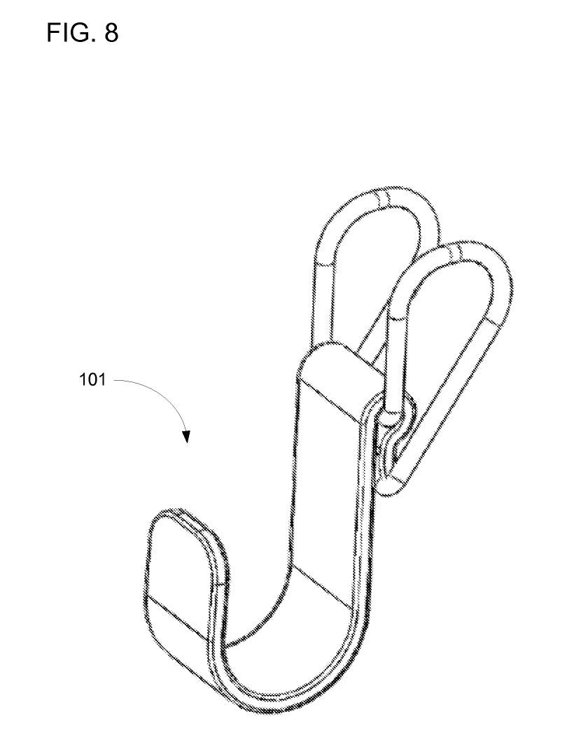

Referring now to FIGS. 6-8, perspective views show the utility hook 101 and the band 111 may be used according to embodiments of the invention. For example, the band 111, which is detachable, enables a wide variety of uses and versatility to wrap around a latch 602 at the back of a seat on a typical commercial aircraft. Alternatively, the combination of the utility hook 101 and the band 111 may wrap around a handle of a suitcase. This is the situation where the handle is relatively short and the band 111 can either be secured on the handle by inserted from the ends of the handle or be secured on the handle through doubled configuration. It is to be understood that a user is able to place the utility hook 101 in a number of different situations. Moreover, as illustrated in FIG. 8, the band 111 may wrap around any horizontal bar where the band 111 could not be secured on the horizontal bar by inserting through the ends thereof.

In an alternative embodiment, there may be two gap sizes between the open-ended catch 109 and the arm member 103. For example, referring to FIG. 3, behind a lip 113 of the open-ended catch 109 is the securing gap Z. Further in the open-ended catch 109, a band resting spot 115 is enclosed between the open-ended catch 109 and the back of the arm member 103. The gap size of the band resting spot 115 should be greater than the gap size of the securing gap Z. In one embodiment, the securing gap Z should be equal or smaller than the thickness of the detachable, but not stretched, band 111. This is to ensure that the band 111 remains within the band resting spot 115, see also FIGS. 4 and 6-8, unless forcibly removed. The band resting spot 115 may be enclosed so that the band 111 may only attach and detach by going through the band lip 113 is the securing gap Z.

Additionally, the band resting spot 115 may be large enough to accommodate at least the thickness of the band 111. In an alternative embodiment, the band resting spot 115 can handle multiple iterations or configurations of the band 111. For example, the band 111 may be doubled or tripled as it is twisted to shorten the length thereof. In one embodiment, while the hook 101 may be made of stiff material, the lip 113 of the open-ended catch 109 may have a stress point that makes it slightly flexible for the band 111 to pass through the securing gap Z with some force to enter the band resting spot 115. In other words, with the construction shown in FIGS. 3 and 4, as well as the dimensions provided herein, a slight tension and resistance is created such that a force needs to be applied to increase the securing gap Z between the back of the arm member 103 and the open-ended catch 109.

It is further to be understood that the band 111 may be placed inside the band resting spot 115 in a number of configurations. For example, FIG. 3 is the side view of the utility hook 101 with the single-band configuration. In the single-band configuration, only one iteration of the band 111 is placed in the band resting spot 115. This allows the utility hook 101 to suspend from latches or other hooks with the original stretch-capability of the band 111. For example, this configuration would allow a user to suspend the hook from a tray table latch 117 on an airplane.

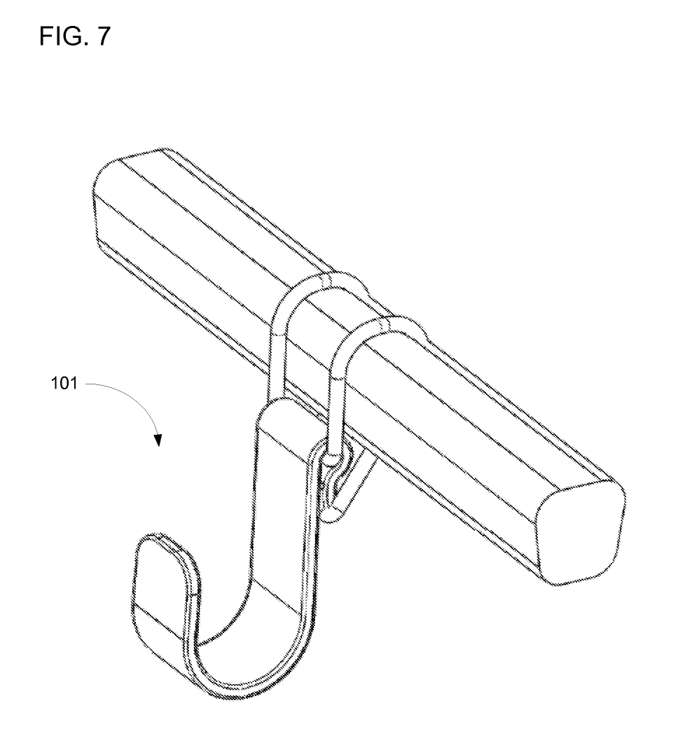

In the illustration shown in FIG. 7, a double-band configuration shows doubling or twisting of the band 111 to be placed in the band resting spot 115. This configuration allows the utility hook 101 to allow support by wrapping around poles or bars. For example, this configuration may allow a user to wrap the utility hook 101 around a luggage handle. With this configuration, it is to be understood that the length of the band 111 is shortened, but the resistance of the band 111 has been increased due to the doubling of the band 111.

It is to be understood that multiple configurations or additional twisting and looping of the band 111 in the band resting spot 115 may be employed without departing from the scope and spirit of the aspects of the invention. These configurations may increase the tension and allow the user to support items of greater weight. It may also allow the user to replace the band 111 if it stretches out over prolonged use. It is also to be understood that multiple bands may be used, as long as the band resting spot 115 may accommodate them.

Aspects of invention herein have been described and illustrated with reference to the embodiments of FIGS. 1-8, but it should be understood that the features and operation of the invention as described is susceptible to modification or alteration without departing significantly from the spirit of the invention as disclosed above. For example, the dimensions, size and shape of the various elements may be altered to fit specific applications. Accordingly, the specific embodiments illustrated and described herein are for illustrative purposes only and the invention is not limited except by the following claims.

What is claimed is:

1. A utility hook for supporting free-standing objects comprising:
an arm member having two ends with one end connecting to an open-ended catch and the other end connecting to a shoulder member;
a hook member connected to the arm member via the shoulder member;
a detachable band engaging with the open-ended catch, said band having a thickness;
wherein the arm member and the hook member are substantially parallel; and
wherein the open-ended catch comprises a securing gap disposed between that and the back of the arm member, said securing gap having a distance smaller than that of the thickness of the band.

2. The utility hook of claim 1, wherein the detachable band is elastic.

3. The utility hook of claim 1, wherein the securing gap between the open-ended catch and the arm member is smaller than the thickness of the detachable band.

4. The utility hook of claim 1, wherein the hook member, the shoulder member, the arm member, and the open-ended catch comprise one continuous piece.

5. The utility hook of claim 1, wherein the open-ended catch comprises a band securing spot surrounded by the back of the arm member and an inner surface of the open-ended catch to accommodate the band.

6. A utility hook for supporting free-standing objects comprising:
an arm member having two ends with one end connecting to an open-ended catch and the other end connecting to a shoulder member;
a hook member connected to the arm member via the shoulder member;
wherein the arm member and the hook member are substantially parallel; and
wherein the open-ended catch comprises a securing gap disposed between that and the back of the arm member.

7. The utility hook of claim 6, further comprising a detachable band engaging with the open-ended catch, said band having a thickness.

8. The utility hook of claim 7, wherein the detachable band is elastic.

9. The utility hook of claim 7, wherein the securing gap having a distance smaller than that of the thickness of the band.

10. The utility hook of claim 7, wherein the securing gap between the open-ended catch and the arm member is smaller than the thickness of the detachable band.

11. The utility hook of claim 6, wherein the hook member, the shoulder member, the arm member, and the open-ended catch comprise one continuous piece.

12. The utility hook of claim 7, wherein the open-ended catch comprises a band securing spot surrounded by the back of the arm member and an inner surface of the open-ended catch to accommodate the band.
